(19) United States
(12) Patent Application Publication
(10) Pub. No.: US 2012/0169771 A1
(43) Pub. Date: Jul. 5, 2012

(54) INFORMATION PRESENTING SYSTEM, INFORMATION PRESENTING METHOD, AND STORAGE MEDIUM

(75) Inventor: Fumitake Muratsu, Tokyo (JP)

(73) Assignee: NEC CORPORATION, Minato-ku, Tokyo (JP)

(21) Appl. No.: 13/386,313

(22) PCT Filed: Jul. 9, 2010
(86) PCT No.: PCT/JP2010/004467

§ 371 Date: Mar. 8, 2012

(30) Foreign Application Priority Data
Jul. 23, 2009 (JP) 2009-172119

(51) Int. Cl. G09G 5/00

(52) U.S. Cl. 345/637

(57) ABSTRACT

An information presenting apparatus includes: a display unit capable of displaying one or more contents; a content storing unit that stores plural contents to be displayed and priority information indicating a priority rank for displaying in a manner that each of the contents and the priority information are associated with each other; a display controlling unit that reads out contents from the content storing unit and displays the contents on the display unit in decreasing order of the priority rank on the basis of the priority information; a selecting unit that selects one or more contents of the contents displayed on the display unit; and a priority information changing unit that changes the priority information associated with a not-selected content group formed by the contents that had been displayed but not selected to lower the priority rank indicated by the priority information.

### TECHNICAL FIELD

The present invention relates to an information presenting system, an information presenting method, and a storage medium.

### BACKGROUND ART

In recent years, in the information explosion age, the amount of user-accessible information exceeds the cognitive limit, and, in some cases, the user cannot reaches contents that the user wishes to obtain. Considering such a situation as a problem, there is a system that automatically selects contents that match user's profile or environmental conditions and displays the selected contents for the user.

As this type of technique, Patent Document 1 (Japanese Patent Application Laid-open No. 2000-187666) describes the following system. This system stores a bookmark for each user as a database, selects information having high similarity with the bookmark in the database, and provides the selected information to the user.

Further, as this type of technique, Patent Document 2 (Japanese Patent Application Laid-open No. 2009-15516) describes the following technique. This system extracts various parameters concerning contents received in the past, determines the order of display of the newly received contents on the basis of the extracted parameters, and displays the contents in accordance with the determined order.

### Related Document

### Patent Document

Patent Document 1: Japanese Patent Application

Laid-open No. 2000-187666

Patent Document 2: Japanese Patent Application Laid-open No. 2009-15516

### SUMMARY OF THE INVENTION

However, the above-described techniques have the following problems. More specifically, while the selected contents are preferentially displayed, the priority rank of the non-selected contents is lowered relatively, which increases the polarization between the displayed contents and the non-displayed contents. This causes the non-displayed contents to remain without being contacted by the user.

The present invention has been made in view of the circumstances described above, and an object of the present invention is to provide an information presenting system, an information presenting method, and a storage medium capable of preventing a non-displayed content from remaining.

According to the present invention, there is provided an information presenting system including: a display unit capable of displaying one or more contents; a content storing unit that stores plural contents to be displayed on the display unit and priority information indicating a priority rank for displaying on the display unit in a manner that each of the contents and the priority information are associated with each other; a display controlling unit that displays a part or all of the contents stored in the content storing unit on the display unit in decreasing order of the priority rank on the basis of the priority information; a selecting unit that receives an operation from a user and selects one or more contents of the contents displayed on the display unit in accordance with the operation; and a priority information changing unit that changes the priority information associated with a not-selected content group formed by the contents that had been displayed on the display unit but not selected by the selecting unit to lower the priority rank indicated by the priority information.

Further, according to the present invention, there is provided an information presenting method including: a display step of causing a display unit capable of displaying one or more contents to display a part or all of the contents stored in a storing unit in decreasing order of a priority rank on the basis of priority information, the storing unit storing the priority information indicating the priority rank for displaying on the display unit in a manner that each of the contents and the priority information are associated with each other; a selecting step of receiving an operation from a user, and selecting one or more of the contents displayed on the display unit in accordance with this operation; and a priority information changing step of changing the priority information associated with a not-selected content group formed by the content that had been displayed in the display step but not selected in the selecting step to lower the priority rank indicated by this priority information.

Yet further, according to the present invention, there is provided a storage medium storing a program read out by a computer, the program causing the computer to execute: a display process of causing a display unit capable of displaying one or more contents to display a part or all of the contents stored in a storing unit in decreasing order of a priority rank on the basis of priority information, the storing unit storing the priority information indicating the priority rank for displaying on the display unit in a manner that each of the contents and the priority information are associated with each other; a selecting process of receiving an operation from a user, and selecting one or more of the contents displayed on the display unit in accordance with this operation; and a priority information changing process of changing the priority information associated with a not-selected content group formed by the content that had been displayed in the display process but not selected in the selecting process to lower the priority rank indicated by said priority information.

According to the present invention, there are provided an information presenting system, an information presenting method, and a storage medium capable of preventing the not-displayed content from remaining.

### BRIEF DESCRIPTION OF THE DRAWINGS

The above-described object and other objects of the present invention, and features and advantages of the present invention will be made further clear by the preferred exemplary embodiment described below and the following drawings attached thereto.

FIG. 1 is a configuration diagram illustrating an information presenting apparatus according to a first exemplary embodiment of the present invention.

FIG. 2 is a schematic view illustrating a display unit of the first exemplary embodiment that displays contents.

FIG. 3 is a diagram illustrating a database stored in a content storing unit.

FIG. 4 is a flowchart illustrating an information presenting method applied to the information presenting apparatus according to the first exemplary embodiment.

FIG. 5 is a configuration diagram illustrating an information presenting system according to a second exemplary embodiment of the present invention.

FIG. 6 is a diagram illustrating a display unit of the second exemplary embodiment that displays contents.

FIG. 7 is a diagram illustrating an example of contents and additional values stored in a change history storing unit.

FIG. 8 is a diagram illustrating an example of a database generated in a database generating unit.

FIG. 9 is a flowchart illustrating an information presenting method applied in the information presenting system according to the second exemplary embodiment.

### DESCRIPTION OF EMBODIMENTS

Hereinbelow, exemplary embodiments of the present invention will be described with reference to the drawings. Note that, in all the drawings, the same constituent components are denoted with the same reference numerals, and explanation thereof will not be repeated as appropriate.

### First Exemplary Embodiment

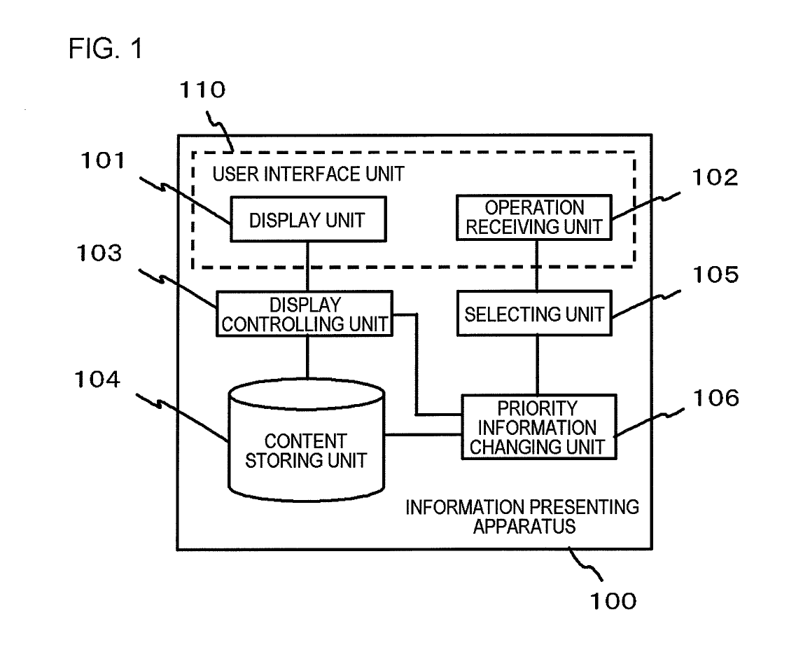

FIG. 1 is a configuration diagram illustrating an information presenting apparatus 100 (information presenting system) according to a first exemplary embodiment of the present invention. The information presenting apparatus 100 has a display unit 101 capable of displaying one or more contents. Further, the information presenting apparatus 100 has a content storing unit 104 that stores plural contents to be displayed on a display unit 101 and priority information indicating a priority rank for displaying on the display unit 101 in a manner that each of the contents and the priority information are associated with each other. Yet further, the information presenting apparatus 100 has a display controlling unit 103 that displays a part or all of the contents stored in the content storing unit 104 on the display unit 101 in decreasing order of the priority rank on the basis of the priority information. Yet further, the information presenting apparatus 100 has an operation receiving unit 102 that receives an operation from a user. Yet further, the information presenting apparatus 100 has a selecting unit 105 that selects one or more contents displayed on the display unit 101 in accordance with the operation received by the operation receiving unit 102. Yet further, the information presenting apparatus 100 has a priority information changing unit 106 that changes priority information associated with a not-selected content group formed by contents that had been displayed on the display unit 101 but not selected by the selecting unit 105 to lower the priority rank indicated by the priority information.

The term “content” as used in the present invention refers to data displayed on a display area, a program containing the data, and more specifically, refers to application software displayed as a hypertext, icon or the like. By selecting a content, it is possible to request a process concerning software (data, program or the like) associated with the content. Here, the requested process may be, for example, an activation of software contained in the apparatus itself, or a transmission (upload) of software contained in the other apparatus.

It should be noted that the content in this exemplary embodiment is data in a text format, and is displayed on the display unit 101 in a list form by the display controlling unit 103. Further, the content may be a hypertext associated with a storage destination of various data and the like.

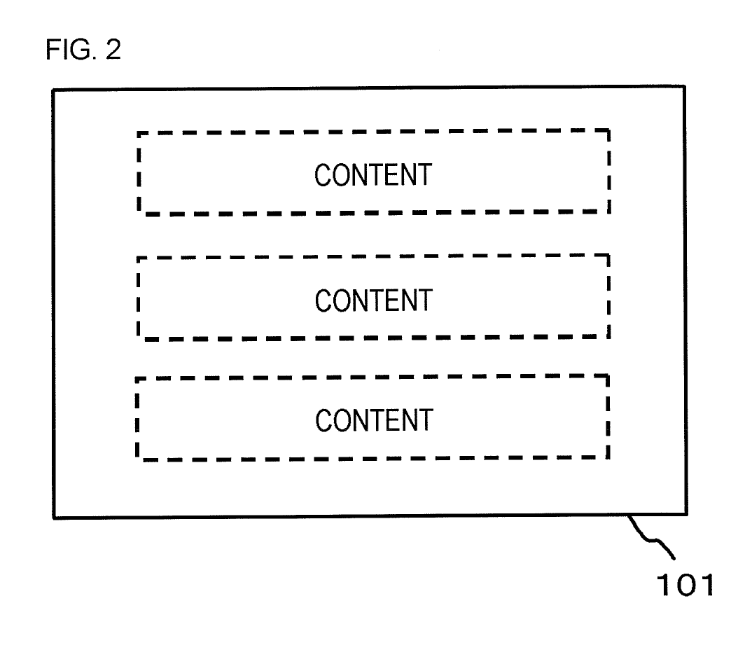

FIG. 2 is a schematic view illustrating the display unit 101 displaying contents (data in a text format). In this drawing, the contents are arranged in the top-bottom direction. However, the contents may be arranged in the right-left direction.

The information presenting apparatus 100 has a user interface unit 110 including at least the display unit 101 and the operation receiving unit 102. Although not illustrated in FIG. 1, the user interface unit 110 may further include a printing unit that performs printing and outputting, a speaker that outputs sound, or a microphone that receives sound input.

The display unit 101 is a display device, and can display one or more contents processed by the display controlling unit 103 in a display area of the display unit 101. The number of contents read out by the display controlling unit 103 may be greater than the number of contents that the display unit 101 can display at the same time. In this case, the display controlling unit 103 may display, in the next page, contents that the display controlling unit 103 reads out but the display unit 101 cannot display. Further, the display controlling unit 103 may have a function of transferring it to the next page in accordance with the operation received from the operation receiving unit 102.

Further, the display area of the display unit 101 may be single, or may be divided into plural areas. Further, the surface area of the display area may be fixed, or may be set so as to be able to be changed.

More specifically, the operation receiving unit 102 is a keyboard, touch panel, mouse or the like. Further, in the case where the operation receiving unit 102 is the touch panel, the operation receiving unit 102 may work integrally with the display unit 101, or may work separately.

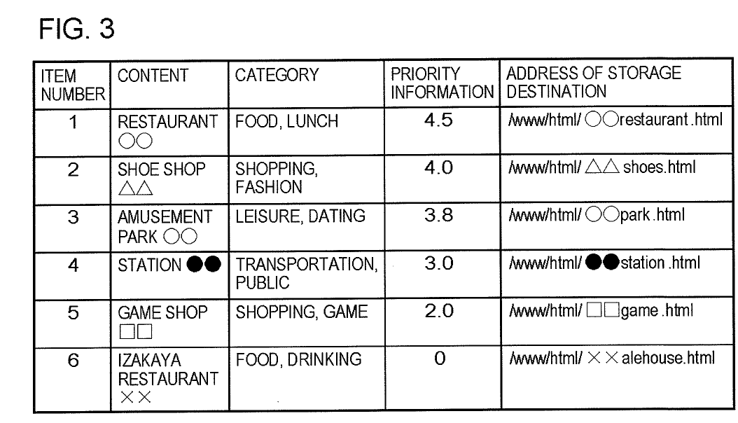

The content storing unit 104 is a database storing, in advance, the contents and the priority information in a manner that each of the contents and the priority information are associated with each other. FIG. 3 is a diagram illustrating a database stored in the content storing unit 104. In addition to the priority information, each of the contents is associated with an item number, a category, and a destination address where software corresponding to the content is stored.

It should be noted that the content stored in the content storing unit 104 may be obtained from an apparatus different from the information presenting apparatus 100, or may be generated in the information presenting apparatus 100.

Positions of the priority rank are expressed by the magnitude of the values of the priority information stored in the content storing unit 104. Note that the priority information may be associated in advance with the contents obtained from the other apparatus. Further, the priority information may be generated at the time when the contents are generated in the information presenting apparatus 100, and be associated with the generated contents. Yet further, the priority information may be generated at the time when the contents are stored in the content storing unit 104, and be associated with the generated contents. In the case where the priority information are generated in the information presenting apparatus 100, the values of the priority information may be determined according to the operation by the user, and may be determined by automatically judging, for example, on the basis of character information of the contents.

Further, the content storing unit 104 stores the contents in a manner that the contents are categorized into plural categories. For example, a content of “restaurant oo” in the item number 1 is categorized into categories of “food” and “lunch.” A content “shoe shop ΔΔ” in the item 2 is categorized into categories of “shopping” and “fashion.” The content storing unit 104 may obtain the contents categorized in advance from the other apparatus and store the categorized contents, or may store the contents categorized in the information presenting apparatus 100. Further, in the case where the contents are categorized in the information presenting apparatus 100, the contents may be categorized in accordance with the operation from the user, or may be categorized by automatically recognizing the contents on the basis of character information of the contents.

The selecting unit 105 selects one or more contents from contents displayed on the display unit 101 in accordance with the operation received by the operation receiving unit 102. Note that the operation of selecting the content may be performed in various manners depending on the modes of the operation receiving unit 102. For example, in the case where the operation receiving unit 102 is a mouse, the content may be designated by a pointer on an operation screen displayed on the displaying unit 101. Further, in the case where the operation receiving unit 102 is a keyboard, the content may be selected by depressing a key corresponding to the content, or by inputting a keyword corresponding to the content.

The priority information changing unit 106 calculates an additional value which is a value to be added to the priority information, and adds the additional value to the priority information to change the priority information. In other words, the priority information changing unit 106 calculates a positive value as the additional value, and adds the additional value to the priority information to increase the value of the priority information in the case of raising the priority rank indicated by the priority information. On the other hand, the priority information changing unit 106 calculates a negative value as the additional value, and adds the additional value to the priority information to lower the value of the priority information in the case of lowering the priority rank indicated by the priority information.

The priority information changing unit 106 changes the priority information associated with the not-selected content group formed by contents that had been displayed on the display unit 101 but not selected by the selecting unit 105, and lowers the priority rank indicated by the priority information. Further, the priority information changing unit 106 changes the priority information associated with the selected content group formed by contents selected by the selecting unit 105, and raises the priority rank indicated by the priority information. In the case of changing the priority information associated with the not-selected content group, the priority information changing unit 106 sets the amount of change (reduction amount) in the priority rank larger, the higher a rank of the content associated with this priority information on the list is.

It should be noted that the priority information changing unit 106 calculates a similarity between the content contained in the selected content group and the content contained in the not-selected content group, and changes the priority information (lowers the priority rank) associated with the content having the similarity lower than a predetermined threshold value (first threshold value) among the contents contained in this not-selected content group. At this time, the content having the similarity greater than the threshold value is highly similar to the selected content, and hence, the priority information changing unit 106 may not change the priority information associated with this content, or may raise the priority rank. The term “similarity” as used herein refers to a similarity of various parameters contained in the content, and the higher similarity means that both contents are highly similar to each other. Further, for the calculation of the similarity described above, it may be possible to employ an appropriate known method for calculating the similarity depending on parameters of the contents to be compared.

It is desirable that the above-described threshold value be set to a lager value, the smaller the number of contents that the display unit 101 can simultaneously display is, and set to a smaller value, the larger the number of contents that the display unit 101 can simultaneously display is. In other words, in the case where the number of contents that can be displayed simultaneously by the display unit 101 is large, the number of the not-selected content is likely to be large, and hence, the threshold value selected by the user is set to be large. Further, in the case where the number of contents that can be displayed simultaneously by the display unit 101 is small, the number of contents contained in the selected content group is likely to be small, which leads to a decrease in the number of content having the high similarity. Thus, the threshold value is set to be low.

It should be noted that the selected content group or not-selected content group described above may be formed by one content, or may be formed by plural contents. Further, the number of the not-selected content group may be zero.

Further, when changing the priority information associated with one content belonging to a first category of plural categories, the priority information changing unit 106 changes the priority information associated with the other content belonging to the first category. Note that the priority information changing unit 106 may set the change amount of the priority information associated with the other content smaller than that of the priority information associated with the one content.

Next, by giving an example of contents illustrated in FIG. 3, a process of changing the priority information by the priority information changing unit 106 will be specifically described. Note that, in this description, it is assumed that the priority information of the content not illustrated in FIG. 3 is not changed.

For example, it is assumed that the display unit 101 displays four contents from the item number 1 to the item number 4, and the selecting unit 105 selects the “restaurant oo” in the item number 1. At this time, the “restaurant oo” is contained in the selected content group, and hence, it is preferable to raise the priority rank. Thus, the priority information changing unit 106 set the additional value of the “restaurant oo” to “1.0.” Further, although the display unit 101 does not display the “izakaya restaurant xx” in the item number 6, the “izakaya restaurant xx” also belongs to the category of “food” common to the item number 1. Thus, the priority information changing unit 106 sets the additional value of the “izakaya restaurant xx” to “0.5.”

Although contained in the not-selected content group, the “amusement park oo” in the item number 3 is a content having a character matching with that contained in the “restaurant oo” in the selected content group, thereby having a high similarity. Thus, the priority information concerning the “amusement park oo” is not subjected to the changing process.

Further, the “shoe shop ΔΔ” in the item number 2 is contained in the not-selected content group, and does not have any character matching with that contained in the “restaurant oo” in the selected content group. That means, the “shoe shop ΔΔ” has a low similarity, and does not belong to any common category, whereby it is preferable to lower the priority rank. Thus, the priority information changing unit 106 sets the additional value of the “shoe shop ΔΔ” to “−0.8.” Similarly, the priority rank of the “station ••” in the item number 4 is preferably lowered, and is displayed at a lower position on the list than that of the “shoe shop ΔΔ.” The priority information changing unit 106 calculates the additional value smaller than that of the “shoe shop ΔΔ,” and sets the additional value of the “station ••” to “−0.6.” Further, although not displayed by the display unit 101, the “game shop□□” in the item number 5 belongs to the category “shopping” common to the item number 2. Thus, the priority information changing unit 106 sets the additional value of the “game shop □□” to “−0.2.”

The above-described manner for determining the additional value is merely one example, and the priority information changing unit 106 may employ various manners for determining the additional value. However, it is desirable that the total sum of the additional values determined by the priority information changing unit 106 be zero. With this setting, during the time when contents stored in the content storing unit 104 remain unchanged, the total sum of the values of the priority information associated with these contents is constant, which makes it possible to prevent the priority rank from unevenly distributing to the higher rank or the lower rank.

The additional value calculated by the priority information changing unit 106 is added to the priority information in the database stored in the content storing unit 104. At this time, a value of the priority information before the addition may be rewritten and deleted, or may be left.

All or a part of the configuration in the information presenting apparatus 100 may be realized by hardware, or may be realized by a program (or program code) that causes a computer to execute processing. In the case where the configuration in the information presenting apparatus 100 is carried out by the program, the computer may be the information presenting apparatus 100, and the program is stored in a storage medium (not illustrated) that the information presenting apparatus 100 (computer) can read out.

The program causes the information presenting apparatus 100 to perform a display process of causing the display unit 101 capable of displaying one or more contents to display a part or all of contents in the content storing unit 104 (storing unit) in decreasing order of a priority rank on the basis of priority information, the content storing unit 104 storing the contents displayed on the display unit 101 and the priority information indicating a priority rank for displaying on the display unit 101 in a manner that each of the contents and the priority information are associated with each other. Further, the program causes the information presenting apparatus 100 to perform a selecting process of receiving the operation from the user and selecting one or more contents displayed on the displayed unit 101 in accordance with the operation. Further, the program causes the information presenting apparatus 100 to perform a priority information changing process of changing the priority information associated with the not-selected content group formed by contents that had been displayed in the display process but not selected in the selecting process to lower the priority rank indicated by this priority information.

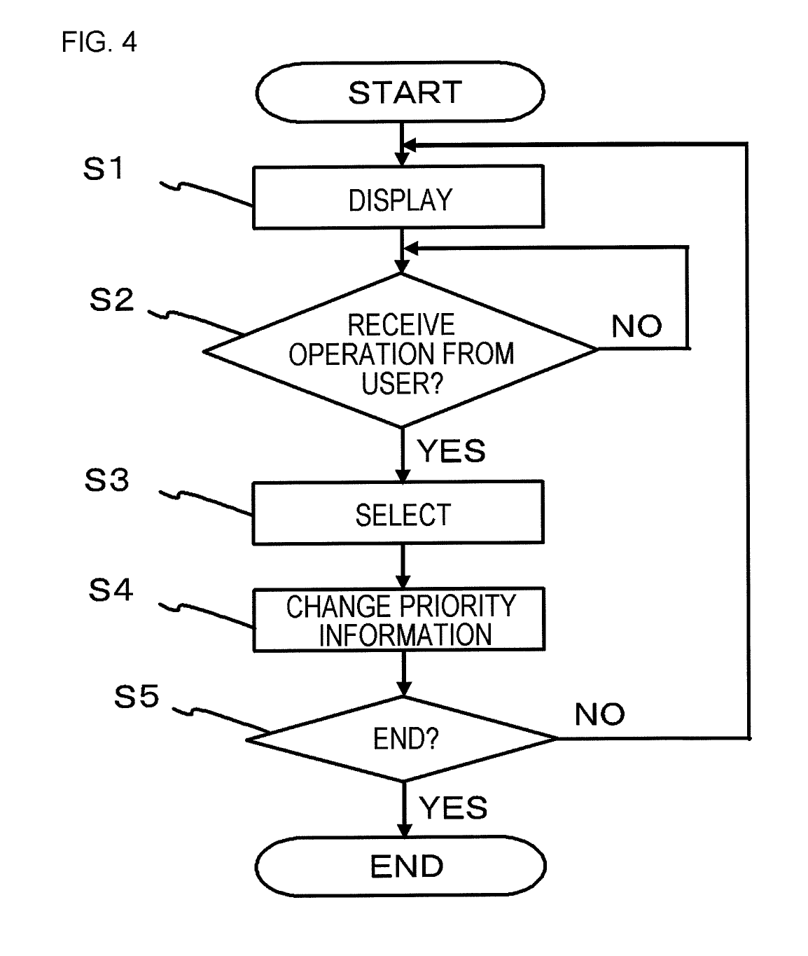

FIG. 4 is a flowchart illustrating an information presenting method applied to the information presenting apparatus 100 of this exemplary embodiment. The information presenting method includes a display step (step S1) of causing the display unit 101 (display unit) capable of displaying one or more contents to display a part or all of contents in the content storing unit 104 (storing unit) in decreasing order of a priority rank on the basis of priority information, the content storing unit 104 storing the contents displayed on the display unit 101 and priority information indicating the priority rank for displaying on the display unit 101 in a manner that each of the contents and the priority information are associated with each other. Further, the information presenting method includes a selecting step (step S3) of receiving an operation of a user (YES in step S2), and selecting one or more contents of the contents displayed on the display unit 101 in accordance with the operation.

It should be noted that, during the time when the operation of the user is not received (NO in step S2), the contents displayed in step S1 are maintained as they are.

Further, the information presenting method includes a priority information changing step (step S4) of changing the priority information associated with the not-selected content group formed by contents that had been displayed in step S1 but not selected in step S3 to lower the priority rank indicated by this priority information; changing the priority information associated with the selected content group formed by contents selected in step S3 to raise the priority rank indicated by this priority information. Note that step S4 includes calculating the similarity between the content contained in the selected content group and the content contained in the not-selected content group, and changing the priority information associated with the content having the similarity lower than that a predetermined threshold value (first threshold value) among the contents contained in the not-selected content group.

This flowchart ends at the time when this information presenting method ends (YES in step S5). The expression “information presenting method ends” as used herein may mean that the power supply to the information presenting apparatus 100 is made off, or may mean that the function of the display unit 101 or the display controlling unit 103 stops.

Further, during the time when this information presenting method is not ended (NO in step S5), step S1 to step S4 are repeated. In step S1, the content is displayed on the display unit 101 on the basis of the priority rank changed in step S4.

Next, effects obtained by this exemplary embodiment will be described. In this exemplary embodiment, the priority rank of the content that had been displayed on the display unit 101 but not selected by the selecting unit 105 is lowered, and hence, the priority rank of the content stored in the content storing unit 104 but not displayed on the display unit 101 is relatively raised. This makes the priority rank of the content stored in the content storing unit 104 in flux, preventing the content displayed on the display unit 101 from being fixed.

Further, according to this exemplary embodiment, the priority rank of the content selected by the selecting unit 105 rises, and hence, the content having a higher frequency of being selected is more likely to be displayed on the display unit 101.

Further, according to this exemplary embodiment, the priority rank is not lowered for the content having a higher similarity with the content selected by the selecting unit 105 than the threshold value, and hence, this content is more likely to remain in a content group that is displayed on the display unit 101.

Further, according to this exemplary embodiment, for plural contents belonging to one category, the change in the priority information of one content leads to the change in the priority information of the other content. Thus, the preferences of the user are more likely to be reflected to the priority rank of the contents.

Further, according to this exemplary embodiment, the change amount of the priority rank is made larger for the content in the higher position displayed in the list form. Thus, for example, in the case where the content displayed in the highest position is not selected, it is deemed that the user has the strong will to refuse the content, and the priority rank thereof can be largely lowered.

Further, according to this exemplary embodiment, the position of the priority rank is indicated by the magnitude of the value, and the change in the priority rank is made through the process of adding the value. Thus, it is possible to finely express each of the priority rank. Additionally, the process of changing the priority rank can be performed through a simple adding process, resulting in a light processing load.

### Second Exemplary Embodiment

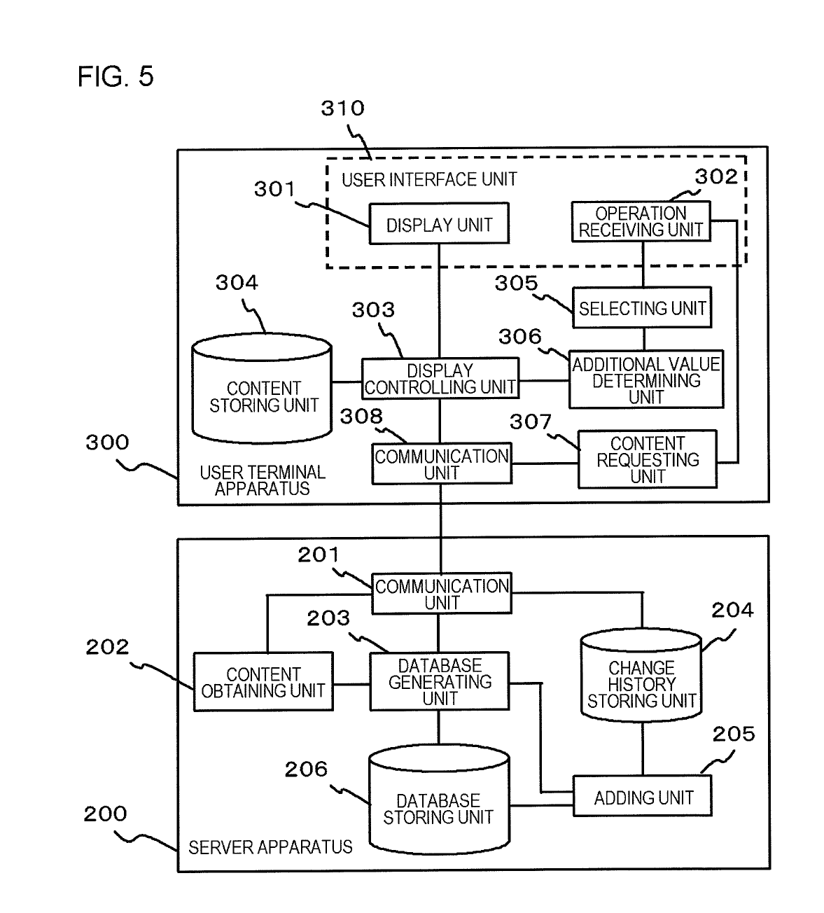

FIG. 5 is a configuration diagram illustrating an information presenting system 1000 according to a second exemplary embodiment of the present invention. The information presenting system 1000 according to this exemplary embodiment has a user terminal apparatus 300 and a server apparatus 200. Note that the user terminal apparatus 300 and the server apparatus 200 can be communicated with each other. Further, the user terminal apparatus 300 may be a fixed terminal, or may be a mobile terminal.

First, constituent elements of the user terminal apparatus 300 will be described. The user terminal apparatus 300 includes a display unit 301, a content storing unit 304, a display controlling unit 303, an operation receiving unit 302, a selecting unit 305, a content requesting unit 307, an additional value determining unit 306, and a communication unit 308. Of these constituent elements, the display unit 301, the display controlling unit 303, the operation receiving unit 302, and the selecting unit 305 can operate similarly to the display unit 101, the display controlling unit 103, the operation receiving unit 102, and the selecting unit 105 described in the first exemplary embodiment.

Further, the user terminal apparatus 300 includes a user interface unit 310 having at least the display unit 301 and the operation receiving unit 302. The user interface unit 310 may further include a printing unit that performs printing and outputting, a speaker that outputs sound, or a microphone that receives sound input, as is the case with the user interface unit 110 of the first exemplary embodiment.

The content requesting unit 307 requests a content to the server 200 (content obtaining unit 202). This request may be generated in accordance with an operation received by the operation receiving unit 302 from a user, or may be generated in accordance with a process by a program, application software or the like stored in the user terminal apparatus 300. This request is made for the purpose of obtaining at least one content, and naturally contains various parameters for identifying the desired content.

It should be noted that the content in this exemplary embodiment is widget application software unless otherwise specified. The widget application software is miniature application software for performing a small-sized task, and plural pieces of widget application software can be displayed on a desktop of a PC screen, a standby screen of a mobile terminal screen or the like. By running the widget application software, it is possible to simultaneously obtain one or plural specific data or one or plural pieces of information provided by specific application software. Note that the expression “simultaneously obtain plural” means obtaining plural pieces of information by running the widget application software at one time.

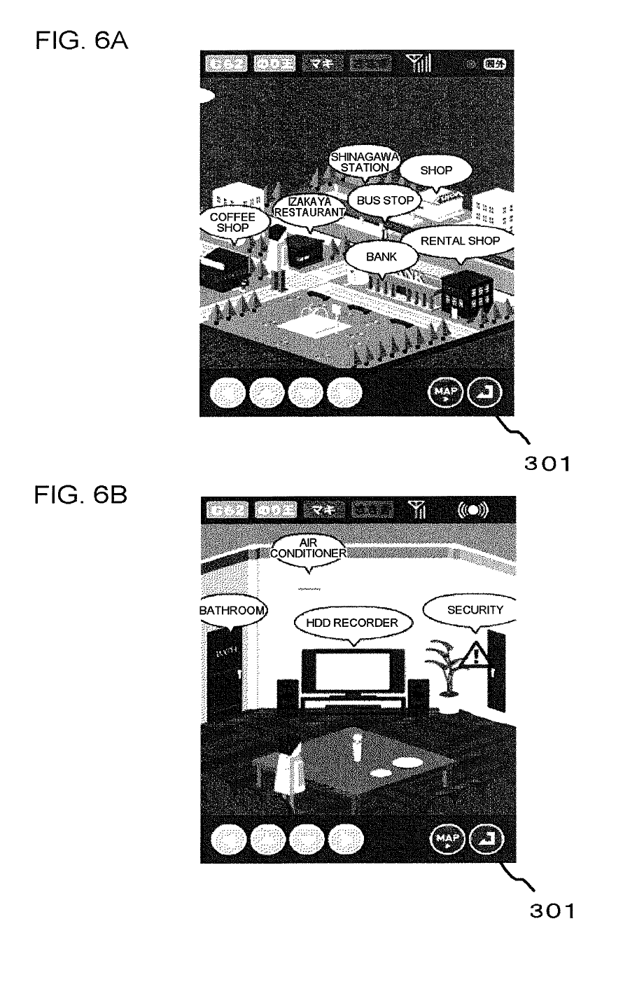

The display controlling unit 303 displays a content as an icon on the display unit 301. FIG. 6 are diagrams each illustrating a display unit 301 displaying contents (widget application software). FIG. 6(A) is a display screen displayed on the display unit 301 at the time when the user stays in a city, and FIG. 6(B) is a display screen displayed on the display unit 301 at the time when the user is at home. Character icons in a word balloon correspond to contents, and information can be read out from a storage destination associated with the content selected by the selecting unit 305.

The additional value determining unit 306 determines an additional value which is a value to be added to the priority information associated with the content subjected to change. The term “content subjected to change” as used herein specifically refers to a content contained in the selected content group, a content contained in the not-selected content group, or a content belonging to the category same as the above-described contents among the contents stored in the content storing unit 304. Further, for determination of the additional value, it may be possible to apply a part or all of the rule of raising or lowering the priority rank described in the first exemplary embodiment.

It should be noted that it is desirable that the total sum of the additional values determined by the additional value determining unit 306 be zero. This is because of the same reason as that described in the first exemplary embodiment.

Further, three constituent elements of the additional value determining unit 306, a changing history storing unit 204 and an adding unit 205, both of which are contained in the server apparatus 200 operate similarly to the priority information changing unit 106 in the first exemplary embodiment.

The communication unit 308 communicatively connects with other apparatuses different from the user terminal apparatus 300. In FIG. 5, the communication unit 308 communicatively connects with the server apparatus 200. Note that, although not illustrated in FIG. 5, the communication connection between the user terminal apparatus 300 and the server apparatus 200 may be made through the Internet, a public telecommunication line, an LAN or other network.

The content storing unit 304 stores a database transmitted from the server apparatus 200 (database generating unit 203) in response to the request made by the content requesting unit 307. The database contains the priority information and the like so as to be associated with the content requested by the content requesting unit 307. Details of the database generated by the database generating unit 203 will be described later.

Next, constituent elements of the server apparatus 200 will be described. The server apparatus 200 includes a communication unit 201, the content obtaining unit 202, the database generating unit 203, the change history storing unit 204, the adding unit 205, and a database storing unit 206.

The communication unit 201 communicatively connects with other apparatuses different from the server apparatus 200. In FIG. 5, the communication unit 201 communicatively connects with the user terminal apparatus 300.

The content obtaining unit 202 obtains a content in response to the request from the content requesting unit 307. Note that the content obtaining unit 202 may obtain the content by receiving this content from the other apparatuses different from the server apparatus 200, or may obtain the content by reading out this content stored in the server apparatus 200.

The database generating unit 203 generates a database in which the contents obtained by the content obtaining unit 202 are associated with the priority information, and stores the generated database in the database storing unit 206. Upon receiving from the adding unit 205 a notification indicative of a completion of adding process of the priority information, the database generating unit 203 transmits the database stored in the database storing unit 206 to the user terminal apparatus 300 (content storing unit 304), and causes the database to be stored.

The change history storing unit 204 stores the additional value determined by the additional value determining unit 306 and the content subjected to change in a manner that the additional value and the content are associated with each other. However, the additional value and the contents stored in the change history storing unit 204 are transmitted from the user terminal apparatus 300 (additional value determining unit 306) to the server apparatus 200 (change history storing unit 204) during the time when the communication connection with the user terminal apparatus 300 is being established.

Further, the change history storing unit 204 stores time information indicating a time corresponding to the additional value in a manner that the time information is associated with the content and the additional value. The time corresponding to the additional value may be a time at which the additional value determining unit 306 determines the additional value, or may be a time at which the additional value is transmitted from the user terminal apparatus 300, or may be a time at which the server apparatus 200 receives the additional value, or may be a time at which the change history storing unit 204 stores the additional value.

In the case where a content contained in the database (database generated by the database generating unit 203) stored in the database storing unit 206 matches with a content subjected to change and stored in the change history storing unit 204, the adding unit 205 adds the additional value associated with the matching content subjected to change to the priority information associated with this content in the database. When the adding process ends, the adding unit 205 notifies the database generating unit 203 to that effect.

Further, the adding unit 205 adds the additional value associated with the time information indicating the time within a predetermined time period to the priority information in the database, and does not add the additional value associated with the time information indicating the time outside the predetermined time period to the priority information in the database. In other words, the adding unit 205 uses the content and the additional value associated with the time information indicating the time within the predetermined time period of all the time information stored in the change history storing unit 204, and changes the priority information in the database stored in the database storing unit 206. Here, the predetermined time period is a time period determined in advance, and maybe set as desired by the operation of the user, or may be set as a default. Note that the time serving as a base point of the predetermined time period is not limited to the time when the database is generated, and may be set as desired.

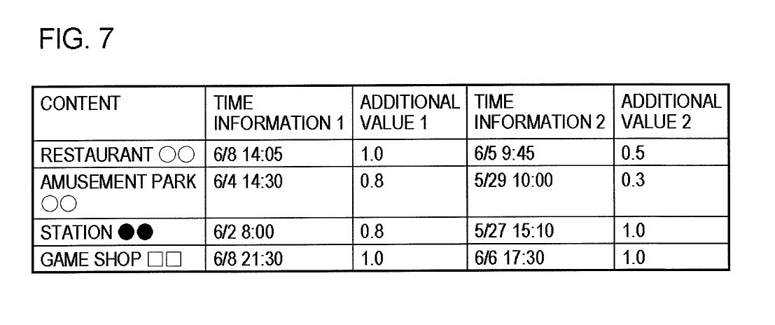

Using a specific example, processes of the database generating unit 203 and the adding unit 205 will be described. FIG. 7 is a diagram illustrating one example of the contents and the additional values stored in the change history storing unit 204. In this example, four types of contents and two types of additional values are each associated with the time information at which the additional values are obtained, and stored. In FIG. 7, although “month,” “day,” and “time” are registered as the time information, “year,” “second” and the like may be included.

It is assumed that the database generating unit 203 generates a database just at noon on June 10. The predetermined time period is set to seven days from the time when the database is generated. At this time, of the additional values illustrated in FIG. 7, the additional value 2 of the “amusement park oo” and the additional value 1 and the additional value 2 of the “station ••” are associated with the time information outside the predetermined time period.

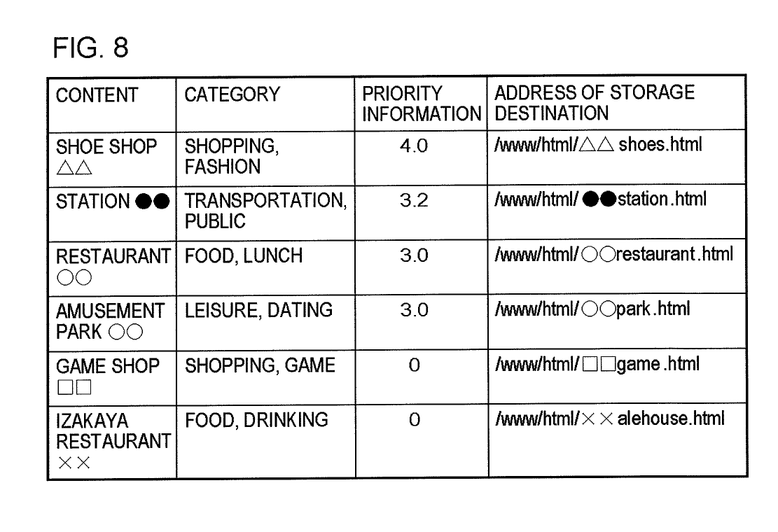

FIG. 8 is a diagram illustrating one example of the database generated by the database generating unit 203. This database is one example in which the content obtaining unit 202 receives six types of contents. In the database, the category to which each of the contents belongs and the address indicating the storage destination of each of the contents are associated with each of the contents. Further, for the content to which the priority information has been already assigned at the time of obtaining the content, the value that has been already assigned is associated with, and for the content to which the priority information has not yet been assigned at the time of obtaining the content, the value “0” is applied.

The adding unit 205 adds the additional value illustrated in FIG. 7 to the priority information in the database illustrated in FIG. 8. For example, in the database in FIG. 8, the priority information of “restaurant oo” is “3.0,”, and in FIG. 7, the additional values associated with the time information indicating the time within the predetermined time period are “1.0” and “0.5.” Thus, the adding unit 205 adds the values described above and rewrites the priority information in the database to “4.5.” Further, the priority information at the time of obtaining the “station ••” is “3.2,” and there is no additional value associated with the time information indicating the time within the predetermined time period. Thus, the adding unit 205 does not perform the adding process, and hence, the value of the priority information in the database results in “3.2.” Further, the “shoe shop ΔΔ” is not contained in the contents illustrated in FIG. 7. Thus, the adding unit 205 does not perform the adding process, and hence, the priority information in the database results in “4.0.” The “izakaya restaurant xx” is not contained in the contents in FIG. 7 similarly to the “shoe shop ΔΔ.” Thus, the adding unit 205 does not perform the adding process, and hence, the priority information in the database results in “0.”

The database generating unit 203 and the adding unit 205 perform their own processes as described above, and item numbers are added to the respective contents, whereby it is possible to generate the database same as that described in the first exemplary embodiment and illustrated in FIG. 3.

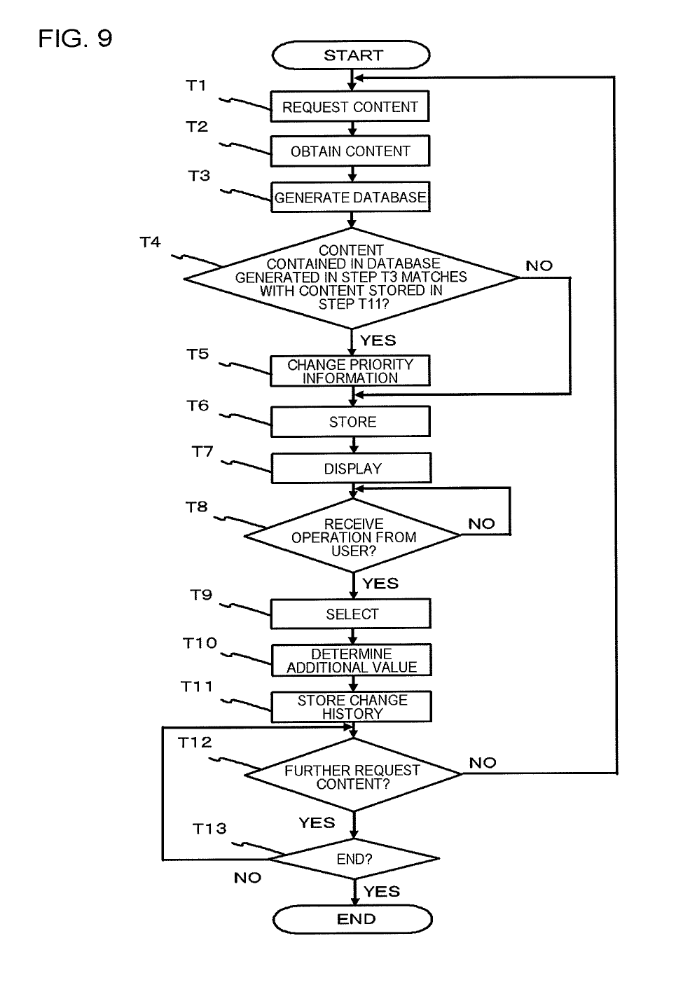

FIG. 9 is a flowchart illustrating the information presenting method applied to the information presenting system 1000 according to this exemplary embodiment. The information presenting method includes a content requesting step (step T1) of requesting the content. Further, the information presenting method includes a content obtaining step (step T2) of obtaining the content requested in the content requesting step. Further, the information presenting method includes a database generating step (step T3) of generating a database in which the content obtained in the content obtaining step is associated with the priority information.

Further, the information presenting method includes a priority information changing step (step T5) of, if the content contained in the database generated instep T3 matches with the content subjected to change and stored in a change history storing step (step T11) (YES in step T4), adding the additional value associated with the matching content subjected to change to the priority information associated with this content in the database.

Further, the information presenting method includes a storing step (step T6) of storing the database generated in a database transmitting step in the content storing unit 304.

It should be noted that, if the content contained in the database generated instep T3 does not match with the content subjected to change and stored in the step T11 (NO in step T4), the process proceeds to step T6, and the database generated in step T3 is stored in the content storing unit 304 without applying any process.

Naturally, if there exists no content subjected to change and stored in the step T11, for example, in the case where the content is requested for the first time or in the case where all the contents subjected to change and stored in step T11 are associated with the time information outside the predetermined time period, step T4 in this flowchart results in NO.

Further, the information presenting method includes a displaying step (step T7) of reading out a part or all of the contents from the content storing unit 304, and causing the display unit 301 to display the read out content in decreasing order of a priority rank on the basis of the priority information. Further, the information presenting method includes a selecting step (step T9) of receiving an operation of the user (YES in step T8), and selecting one or more contents among the contents displayed on the display unit 301 in accordance with the operation.

It should be noted that, during the time when the operation of the user is not received (NO in step T8), the contents displayed in step T7 are maintained as they are.

Further, the information presenting method includes an additional value determining step (step T10) of determining the additional value, which is a value to be added to the priority information associated with the content subjected to change. Further, the information presenting method includes the change history storing step (step T11) of storing the additional value determined in the additional value determining step and the content subjected to change in a manner that the additional value and the content are associated with each other.

It should be noted that the content subjected to change here refers to any of the not-selected content group formed by contents that had been displayed in step T7 but not selected in step T9, the selected content group formed by contents selected in step T9, and the content belonging to the same category as that of the not-selected content group and the selected content group.

If the content is further requested (YES in step T12), the information presenting method repeats the processes again from step T1.

Further, if no further content is requested (NO in step T12) and the information presenting method is ended (YES in step T13), this flowchart ends. Here, the end of the information presenting method may mean disconnecting the communication connection between the user terminal apparatus 300 and the server apparatus 200, or causing the user terminal apparatus 300 to log out from a site provided by the server apparatus 200, or stopping the function of the display unit 301 or the display controlling unit 303.

Further, if the information presenting method is not ended (NO in step T13), the information presenting method keeps standby state until the next content request.

Next, effects obtained by this exemplary embodiment will be described. In this exemplary embodiment, the obtainment of the content and the generation of the database, which cause relatively large load, are performed by the server apparatus 200, and hence, the processes performed by the user terminal apparatus 300 are limited to processes (displaying process and selecting process of the content) concerning the user. Thus, the weight reduction and the mobilization of the user terminal apparatus 300 can be easily achieved.

Further, in this exemplary embodiment, the user terminal apparatus 300 contains the additional value determining unit 306. Thus, it is possible to reduce the data capacity required for memorizing the history of the process of selecting the content. This is effective in reducing the storage capacity of the change history storing unit 204.

Further, this exemplary embodiment obtains the content, generates the database, reads out the content contained in the database, and displays it every time when requesting the content. Thus, it is possible for the content storing unit 304 (storing unit on the side of the user terminal apparatus 300) to reduce the period of time for storing the content. Needless to say, the period of time for storing the content may be determined by the user as desired.

Further, this exemplary embodiment adds the additional value associated with the time information within the predetermined time period to the priority information associated with the content subjected to change. Thus, it is possible to reflect the selection of the content performed in the predetermined time period to the change in the priority rank.

As described above, the exemplary embodiments of the present invention have been described with reference to the drawing. These are merely examples of the present invention, and it may be possible to employ various configurations other than those described above.

Data tables illustrated in FIG. 3, FIG. 7 and FIG. 8 are merely examples of the above-described exemplary embodiments, and it may be possible to increase or decrease the number of contents or the number of item numbers of the data.

The first exemplary embodiment and the second exemplary embodiment described that the higher priority rank represents the higher value of the priority information, and the lower priority rank represents the lower value of the priority information. However, these exemplary embodiments are not limited to this. For example, by treating the item numbers attached to the contents in FIG. 3 as the priority information, it may be possible to treat the lower item number as the higher priority rank, and the higher item number as the lower prior rank.

In the first exemplary embodiment and the second exemplary embodiment, the priority information changing unit 106 or the adding unit 205 changes the priority information only through the adding process. However, these exemplary embodiments are not limited to this. The priority information may be change through other calculation process such as a subtraction process, a multiplication process, and a division process, or may be changed through a process obtained by combining these calculation processes.

In the second exemplary embodiment, the constituent elements in the user terminal apparatus 300 and the server apparatus 200 are merely examples. For example, the server apparatus 200 may include a constituent element having a function equivalent to the additional value determining unit 306 of the user terminal apparatus 300.

The first exemplary embodiment describes that the display controlling unit 103 may read out all the contents stored in the content storing unit 104 and display the contents. However, it may be possible to inhibit the reading out of the content having the priority rank with extremely low value. In other words, the display controlling unit 103 may read out the content associated with the priority information having the value larger than a predetermined threshold value (second threshold value) from the content storing unit 104, and display the read-out content on the display unit 101. This makes it possible to reduce the process of reading out the content having the extremely low priority rank. Further, in the case where the content is obtained from an external system and is stored in the content storing unit 104, the external system may have a function of reducing the value of the priority information associated with the content having a possibility of being spam. In this case, the display controlling unit 103 can prevent reading out of the content having the possibility of being spam from being read out.

In the second exemplary embodiment, even during the time when the communication connection between the user terminal apparatus 300 and the server apparatus 200 is not established, the content can be displayed on the display unit 301, and hence, the user can select the content. In order to store this history in the change history storing unit 204, the user terminal apparatus 300 may include a storage area that temporarily stores the additional value determined by the additional value determining unit 306 and the content subjected to change. Then, upon re-connecting between the user terminal apparatus 300 and the server apparatus 200, the additional value and the content stored in the storage area may be outputted to the server apparatus 200 (change history storing unit 204). As is the case with the change history storing unit 204, it is only necessary that this storage area stores the additional value and the content as the history through the process performed by the additional value determining unit 306, and hence, it is possible to reduce the capacity thereof.

In the second exemplary embodiment, a description has been made that the display controlling unit 303 displays a content as an icon on the display unit 301. In this case, the content having the larger surface area is more likely to attract user's attention. That is, if the user does not select such a content, the user is considered to have the strong will to refuse the content. Thus, when changing the priority information associated with the not-selected content group, the adding unit 205 (priority information changing unit) may set the change amount (negative value to be added) for the priority rank larger, the larger the surface area of the icon indicating the content associated with this priority information is.

Further, in the case where a specific position in the display area of the display unit 301 is displayed in a manner that attracts the attention of the user, it can be considered that the user has the strong will to refuse the content if the user does not select such a content. In this case, when changing the priority information associated with the not-selected content group, the adding unit 205 (priority information changing unit) may vary the amount of change (additional value) for the priority rank according to the display position of the icon indicating the content associated with this priority information. The specific position described above maybe the center of the display area of the display unit 301.

In the second exemplary embodiment, although the description has been made that the server apparatus 200 and the user terminal apparatus 300 have a one-to-one relationship, they may have one-to-N (plural) relationship. In other words, it may be possible to employ a configuration in which one serve apparatus 200 can be communicated with plural user terminals. In this case, the change history storing unit 204 may store the additional values obtained from the plural user terminal apparatuses and the contents subjected to change. Further, when the database generating unit 203 generates a database in response to the request from one user terminal apparatus, the adding unit 205 may change the priority information in the database by using an additional value obtained from the other user terminal apparatus and the content subjected to change. This makes it possible to reflect the selection of content by users of the plural user terminal apparatuses to the priority rank of the content.

Further, in the above-described exemplary embodiments, an example has been given, in which each of the units of the information presenting system is realized logically as various functions by a computer program. However, each of these units may be formed independently by hardware, or may be realized by a combination of software and hardware.

It should be noted that, naturally, the above-described exemplary embodiments and plural modification examples can be combined, provided that contents thereof do not contradict each other. Further, in the above-described exemplary embodiments and modification examples thereof, functions of the constituting elements have been specifically described. These functions may be changed within the scope that satisfies the present invention.

Further, in the information presenting method according to the present invention, plural steps are specified in a sequential order. However, this specification of the order does not limit the order in which the plural steps are performed. Therefore, at the time of performing the information presenting method according to the present invention, the order of the plural steps may be changed, provided that such a change does not impair the contents thereof.

The present application claims priority based on Japanese Patent Application No. 2009-172119 filed in Japan on Jul. 23, 2009, all of which disclosure is incorporated herein by reference.

1. An information presenting system comprising:
a display unit capable of displaying one or more contents;
a content storing unit that stores a plurality of contents to be displayed on the display unit and priority information indicating a priority rank for displaying on the display unit in a manner that each of the contents and the priority information are associated with each other;
a display controlling unit that displays a part or all of the plurality of contents stored in the content storing unit on the display unit in decreasing order of the priority rank on the basis of the priority information;
a selecting unit that receives an operation from a user and selects one or more contents of the contents displayed on the display unit in accordance with the operation; and
a priority information changing unit that changes the priority information associated with a not-selected content group formed by the contents that had been displayed on the display unit but not selected by the selecting unit to lower the priority rank indicated by said priority information.

2. The information presenting system, according to claim 1, wherein
the priority information changing unit changes the priority information associated with a selected content group formed by the content selected by the selecting unit to raise the priority rank indicated by said priority information.

3. The information presenting system according to claim 2, wherein
the priority information changing unit calculates a similarity between the content contained in the selected content group and the content contained in the not-selected content group, and changes the priority information associated with the content having the similarity smaller than a predetermined first threshold value among the contents contained in the not-selected content group.

4. The information presenting system according to claim 3, wherein
the first threshold value is set larger, the smaller the number of contents that the display unit can display at the same time is, and is set smaller, the larger the number of contents that the display unit can display at the same time is.

5. The information presenting system according to claim 1, wherein
the content storing unit categorizes the plurality of contents into a plurality of categories to store the plurality of contents, and
when changing the priority information associated with one content belonging to a first category of the plurality of categories, the priority information changing unit changes the priority information associated with the other content belonging to the first category.

6. The information presenting system according to claim 5, wherein
the priority information changing unit sets an amount of change in the priority information associated with the other content smaller than the amount of change in the priority information associated with the one content.

7. The information presenting system according to claim 1, wherein
the display controlling unit displays the contents on the display unit in a list form, and
when changing the priority information associated with the not-selected content group, the priority information changing unit sets an amount of change in the priority rank larger, the higher a rank of the content associated with said priority information on the list is.

8. The information presenting system according to claim 1, wherein
the display controlling unit displays the content as an icon on the display unit, and
when changing the priority information associated with the not-selected content group, the priority information changing unit sets an amount of change in the priority rank larger, the larger a surface area of the icon indicating the content associated with said priority information is.

9. The information presenting system according to claim 8, wherein
when changing the priority information associated with the not-selected content group, the priority information changing unit varies the amount of change in the priority rank according to a display position of the icon indicating the content associated with said priority information.

10. The information presenting system according to claim 1, wherein
the priority information presents a position of the priority rank, numerically.

11. The information presenting system according to claim 10, wherein
the display controlling unit reads out, from the content storing unit, the content associated with the priority information having a value larger than a predetermined second threshold value, and displays the read-out content on the display unit.

12. The information presenting system according to claim 1, further comprising:
a content requesting unit that requests the content;
a content obtaining unit that obtains the content requested by the content requesting unit; and
a database generating unit that generates a database in which the content obtained by the content obtaining unit is associated with the priority information, and stores the generated database in the content storing unit.

13. The information presenting system according to claim 12, wherein
the priority information changing unit comprises:
an additional value determining unit that determines an additional value which is a value to be added to the priority information associated with a content subjected to change;
a change history storing unit that stores the additional value determined by the additional value determining unit and the content subjected to change in a manner that the additional value and the content subjected to change are associated with each other; and
an adding unit that, in the case where a content contained in the database generated by the database generating unit matches with the content subjected to change and stored in the change history storing unit, adds the additional value associated with the matching content subjected to change to the priority information associated with the content in the database.

14. The information presenting system according to claim 13, wherein
the change history storing unit stores time information indicating a time corresponding to the additional value in a manner that the time information is associated with the content and the additional value, and
the adding unit adds the additional value associated with the time information indicating a time within a predetermined time period to the priority information in the database.

15. The information presenting system according to claim 13, wherein
the total sum of the additional value determined by the additional value determining unit is zero.

16. The information presenting system according to claim 13, wherein
the information presenting system comprises:
a user terminal apparatus including the display unit, the content storing unit, the display controlling unit, the selecting unit, the content requesting unit, and the additional value determining unit; and
a server apparatus including the content obtaining unit, the database generating unit, the change history storing unit, and the adding unit,
said user terminal apparatus and said server apparatus are able to be communicated with each other.

17. The information presenting system according to claim 16, wherein
the server apparatus can be communicated with a plurality of user terminal apparatuses,
the change history storing unit stores the additional value obtained from the plurality of the user terminal apparatuses and the content subjected to change, and
when the database generating unit generates the database in response to a request from the user terminal apparatus, the adding unit changes the priority information in said database using the additional value obtained from another user terminal apparatus and the content subjected to change.

18. An information presenting method including:
causing a display unit capable of displaying one or more contents to display a part or all of the contents stored in a storing unit in decreasing order of a priority rank on the basis of priority information, the storing unit storing the contents and the priority information indicating the priority rank for displaying on the display unit in a manner that each of the contents and the priority information are associated with each other;
receiving an operation from a user;
selecting one or more of the contents displayed on the display unit in accordance with said operation; and
changing step of changing the priority information associated with a not-selected content group formed by the content that had been displayed but not selected to lower the priority rank indicated by said priority information.

19. The information presenting method according to claim 18, further including
changing the priority information associated with a selected content group formed by the content selected to raise the priority rank indicated by said priority information.

20. The information presenting method according to claim 19, further including
calculating a similarity between the content contained in the selected content group and the content contained in the not-selected content group, wherein
said changing the priority information includes changing the priority information associated with the content having the similarity smaller than a predetermined first threshold value among the contents contained in the not-selected content group.

21. The information presenting method according to claim 20, wherein
the first threshold value is set larger, the smaller the number of contents that the display unit can display at the same time is, and is set smaller, the larger the number of contents that the display unit can display at the same time is.

22. The information presenting method according to claim 18, wherein
the storing unit categorizes the plurality of contents into a plurality of categories to store the plurality of contents, and
said changing the priority information includes changing, when changing the priority information associated with one content belonging to a first category of the plurality of categories, the priority information associated with the other content belonging to the first category.

23. The information presenting method according to claim 22, wherein
the amount of change in the priority information associated with the other content is set smaller than the amount of change in the priority information associated with the one content.

24. The information presenting method according to claim 18, wherein
the display unit displays the content in a list form, and
said changing the priority information includes setting, when changing the priority information associated with the not-selected content group, an amount of change in the priority rank larger, the higher a rank of the content associated with said priority information in the list is.

25. The information presenting method according to claim 18, wherein
the display unit displays the content as an icon, and,
said changing the priority information includes setting, when changing the priority information associated with the not-selected content group, an amount of change in the priority rank larger, the larger a surface area of the icon indicating the content associated with said priority information is.

26. The information presenting method according to claim 25, wherein
said changing the priority information includes varying, when changing the priority information associated with the not-selected content group, the amount of change in the priority rank according to a display position of the icon indicating the content associated with said priority information.

27. The information presenting method according to claim 18, wherein
the priority information presents a position of the priority rank, numerically.

28. The information presenting method according to claim 27, further including
reading out, from the storing unit, the content associated with the priority information having a larger value than a predetermined second threshold value to display the read-out content on the display unit.

29. The information presenting method according to claim 18, further including:
requesting the content;
obtaining the requested content
generating a database in which the obtained content is associated with the priority information; and
storing, in the storing unit, the generated database.

30. The information presenting method according to claim 29, further including:
determining an additional value which is a value to be added to the priority information associated with a content subjected to change; and
storing the additional value and the content subjected to change in a manner that the additional value and the content subjected to change are associated with each other, and
when a content contained in the database matches with the content subjected to change and stored, the additional value associated with the matching content subjected to change is added to the priority information associated with said content in the database.

31. The information presenting method according to claim 30, wherein
time information indicating a time corresponding to the additional value is stored so as to be associated with said content and said additional value, and
the additional value associated with the time information indicating a time within a predetermined time period is added to the priority information in the database.

32. The information presenting method according to claim 30, wherein
the total sum of the additional value determined in the additional value determining step is zero.

33. A storage medium storing a program read out by a computer, the program causing the computer to execute:
a display process of causing a display unit capable of displaying one or more contents to display a part or all of the contents stored in a storing unit in decreasing order of a priority rank on the basis of priority information, the storing unit storing the contents and the priority information indicating the priority rank for displaying on the display unit in a manner that each of the contents and the priority information are associated with each other;
a selecting process of receiving an operation from a user, and selecting one or more of the contents displayed on the display unit in accordance with said operation; and
a priority information changing process of changing the priority information associated with a not-selected content group formed by the content that had been displayed in the display process but not selected in the selecting process to lower the priority rank indicated by said priority information.
